(19) United States
(12) Patent Application Publication
(10) Pub. No.: US 2009/0094829 A1
(43) Pub. Date: Apr. 16, 2009

(54) Method for ultrasonic peening of gas turbine engine components without engine disassembly

(75) Inventors: Billie W. Bunting, Colchester, CT (US); Leonard Paul Palmisano, Forestville, CT (US); Edward R. Brown, East Hartford, CT (US); David R. Malley, Bolton, CT (US); David A. Rutz, Glastonbury, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 11/974,581

(22) Filed: Oct. 15, 2007

(51) Int. Cl. B23P 6/00; C21D 7/06

(52) U.S. Cl. 29/888.021; 72/53

(57) ABSTRACT

A method for peening a component of a gas turbine engine, or a module of a gas turbine engine, without removing the component from the assembled gas turbine engine or module includes blending the damaged area of the component, determining parameters for peening the damaged component, and peening the damaged component without removing it from the engine.

### BACKGROUND OF THE INVENTION

The invention relates to ultrasonic peening. More specifically, the invention relates to a method of peening gas turbine engine components without disassembling the gas turbine engine or engine module. This method of in situ peening reduces the cost and time to repair damaged components of gas turbine engines. There is no need to disassemble the engine or engine module in order to repair damaged components, nor is there a need to reassemble the engine or engine module after the repair has been accomplished. Additionally, since traditional shot peening processes involve the use of extensive specialized equipment that is usually only available at shops specializing in peening processes, the invention avoids the need to ship components to third parties for peening. As a result, damaged components of gas turbine engines can be repaired in a more efficient and more economical manner.

Components of gas turbine engines, such as fan hubs, disks, drums and shafts, are sometimes damaged due to impact with foreign objects or some other cause. Shallow damage to a fan hub can be repaired by locally blending the damaged area to remove the distressed material. However, the hub must then be peened to restore the residual compressive stresses to the damaged and repaired area.

Peening is a well-known process used to impart a layer of residual compressive stresses onto metals. Typically, steel shot is blasted at a metal surface by a jet of compressed air, so that the steel shot impacts the target piece of metal. However, peening can only be performed in a space that is adapted for recovering the steel shot that rebounds after impact with the target. It also requires a large supply of steel shot.

Before a damaged engine component can be repaired by peening, the engine must be disassembled and the damaged component must be removed. Disassembly of a gas turbine engine is a complicated and time-consuming task. Even after the damaged component has been removed and repaired, repair facilities often lack the capability to conduct peening processes, so the damaged component must be shipped to a third party for repair. As a result, the time and expense required for such a repair can result in significant expense, delay and customer dissatisfaction.

Under some special circumstances, it is possible to peen a component that is still assembled in the engine. However, in order to do so it is necessary to mask the rest of the engine to assure with certainty that no peening media, such as steel shot, can possibly enter the engine. Stray shot that enters the engine has the potential to cause extensive damage. This masking process is very burdensome and therefore not commercially practical. Even with masking, there is considerable risk that stray peening media may be introduced into the gas turbine engine, causing considerable damage.

Thus, there is a need in the art for a peening process that can be used to repair damaged components of a gas turbine engine with minimal or no disassembly of the engine. The process should be simple enough that it can be performed without having to send the damaged component to a third party for repair, and it should avoid the danger of introducing stray peening media into the engine.

### BRIEF SUMMARY OF THE INVENTION

The invention is a method for peening a component of a gas turbine engine without removing the component from the assembled gas turbine engine or an engine module. In situ peening of the component reduces the time and expense of repair and reduces the time during which the gas turbine engine is not operative. As a result, repairs can be performed more efficiently and economically, resulting in greater customer satisfaction.

### BRIEF DESCRIPTION OF THE DRAWINGS

FIG. 1 is a flow diagram showing the in situ peening process.

FIG. 2 is a drawing of a section of a section of a fan hub of a gas turbine engine.

FIG. 3 is a cross sectional diagram showing the invention method being applied to a fan hub of a gas turbine engine.

### DETAILED DESCRIPTION

Utilizing a self-contained shot peening apparatus, damaged components of gas turbine engines, such as fan hubs, can be repaired without having to disassemble the engine and remove the damaged component prior to repair. The self-contained peening apparatus includes a vibrating surface and projectiles that are projected toward a target surface by the vibrating surface. In such an apparatus, retaining means keep each projectile captive in the apparatus, so that the peening media does not stray. Using a self-contained peening apparatus to repair damaged parts without having to remove the damaged parts from the engine reduces the time and expense of repairs. Reduced time and expense of repair leads to reduced time that the gas turbine engine is not operative and results in greater customer satisfaction.

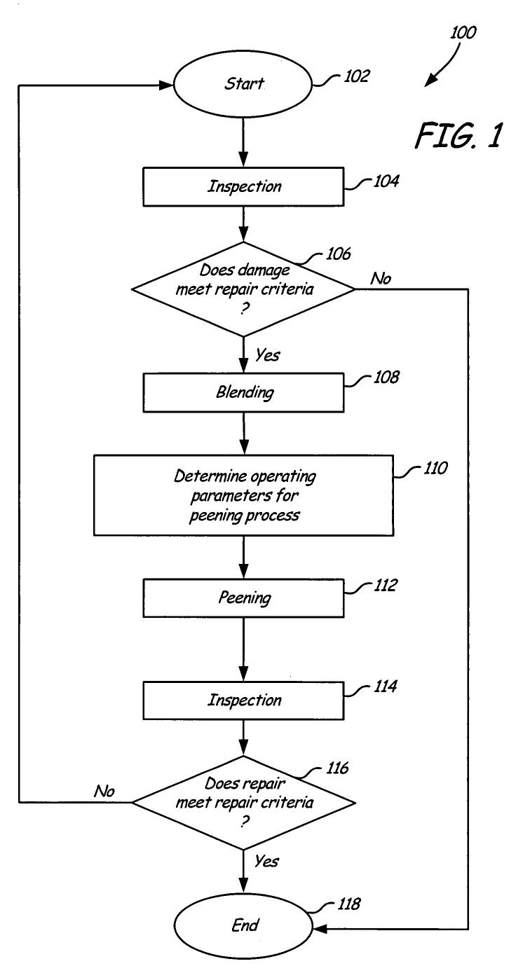

FIG. 1 is a flow diagram 100 showing the method of repairing a damaged engine component using a peening process without having to disassemble the engine. The process begins at Start Box 102. The process then moves to box 104, where the damaged component is inspected. A repair inspector examines the damaged component to ascertain the nature and extent of the damages, including the location of the damage and the length, width and depth of the damage.

The process then proceeds to decision box 106, where it is determined whether the damage can be repaired and restored to an airworthy state using in situ peening. If not, the process ends. However, if the damage can be removed by blending and the required compressive stresses restored by utilizing in situ peening, the process moves on to box 108. At box 108, the damage area is ‘blended’. Blending is the intentional removal of base material using hand-held rotating abrasive wheels and pads. At this step, the damaged area is smoothed in order to remove any sharp edges or rough surfaces.

Next, the repair person determines the necessary parameters for the peening process at box 110. Peening is performed according to operating parameters that are determined for each particular component, such as the size and shape of the peening media; the material of the peening media; the size, frequency and amplitude of the vibrating surface of the peening apparatus; peening coverage; orientation of the vibrating surface of the peening apparatus with respect to the damaged area of the damaged component; and peening time. These parameters are varied to produce the appropriate peening intensity.

Once the operating parameters have been determined, the process moves on to box 112, where the actual peening of the damaged component takes place. Damaged components typically may include the fan hub corner radius, another fan hub location, or even another type of component in the engine assembly.

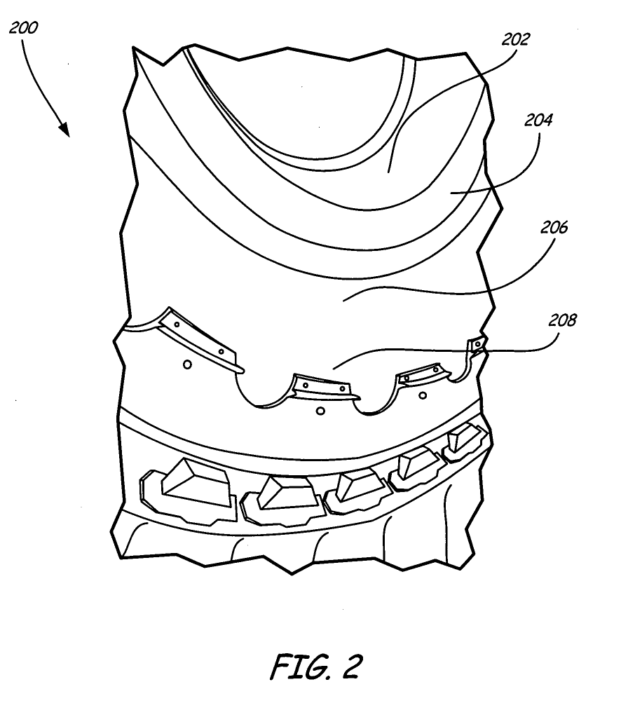

FIG. 2 shows a typical fan hub 200 of a gas turbine engine. Fan hub 200 includes bore 202, face 204, fillet 206, and web 208.

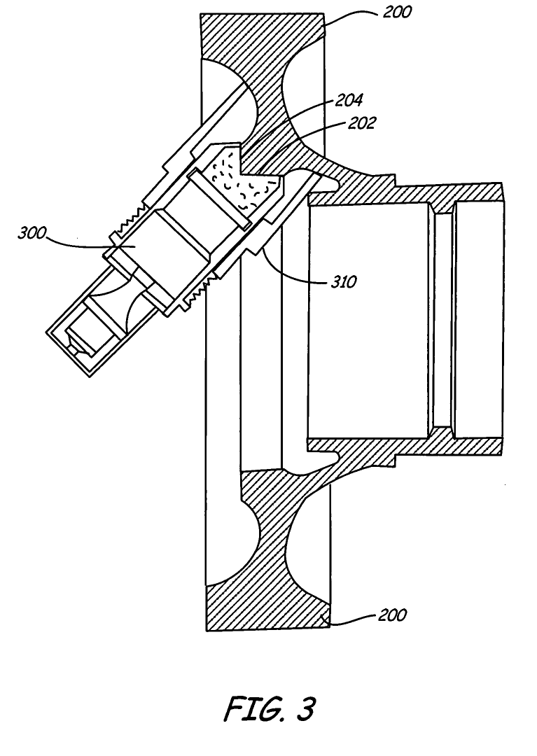

FIG. 3 shows a cross sectional diagram showing the fan hub 200 from FIG. 2, along with a self-contained peening apparatus 300 positioned against fan hub 200. In practicing the invention, peening apparatus 300 is directed toward the surface portion of fan hub 200 upon which peening is desired. By utilizing peening apparatus 300, a surface of fan hub 200 may be peened without removing fan hub 200 from the rest of the gas turbine engine.

Self-contained peening apparatus 300 may be of the type disclosed in U.S. Pat. No. 6,343,495, which is incorporated herein by reference. The apparatus includes a vibrating surface and a number of projectiles that are directed towards the target surface. The apparatus also includes a structure for keeping each projectile captive in the self-contained peening apparatus, so that the peening media cannot escape and damage or get loose in other parts of the aircraft engine.

In practice, a shot peening operator installs a peening apparatus against the area of the damaged component that is to be peened. The peening operator turns on the peening apparatus and the apparatus is moved back and forth on the area to be peened by a robot or other automatic method.

The peening media in the peening apparatus are completely contained and cannot escape. There can also be tooling designed to protect critical areas of the engine for additional protection against media escape. This eliminates the need for expensive, high-risk masking operations that attempt to prevent peening media from entering other parts of the engine. The equipment also eliminates any need for engine disassembly, shipment to outside peening suppliers, or engine reassembly. In situ peening also eliminates the danger that assembly and reassembly operations can introduce further damage to the gas turbine engine components.

For example, weld repairs on turbine exhaust cases require shot peening of the welded areas. Although welding can be performed in most repair shops, shot peening is typically performed at an outside shop that specializes in peening processes. This adds additional time and cost to the repair. Also, if the turbine exhaust case is assembled to the engine, additional assembly and disassembly time is required. Previously, to avoid these problems, repairs have been conducted by either waiving the shot peening requirement or allowing flapper peening instead of conventional shot peening. Utilizing the invention, disassembly and reassembly are no longer required. Thus, repairs can be performed using shot peening, without having to compromise on the quality of the repairs.

The invention can be applied to components that are installed in an engine module. The module may be removed from the engine assembly, but will remain assembled for limited or light maintenance. Some examples of module level applications include components such as HPC front hubs, HPC discs and drums, turbine exhaust cases, and front compressor drive turbine shafts. Furthermore, local peening of circumferential blade slots is beneficial to avoid having to send HPC drums to a third party for peening.

After peening has been completed at box 112, the process moves on to box 114, where the repair work is inspected. Inspection includes visual examination using magnification under white light. Such visual inspection is required on any component after peening by conventional methods as well. Next, at decision box 114, it is determined whether the repair work is satisfactory. If so, the process ends at end box 118. If the repair work is not satisfactory, the process returns to start box 102 and begins again.

The invention is a method for shot peening the component of a gas turbine engine without removing the component from the gas turbine engine or masking any of the engine components. The method reduces the cost of repair, the time needed for repair and the amount of time that the gas turbine engine is not in operation. This increased efficiency and economy results in better performance of the engine and greater customer satisfaction.

Although the present invention has been described with reference to preferred embodiments, workers skilled in the art will recognize that changes may be made in form and detail without departing from the spirit and scope of the invention.

1. A method for repairing a damaged component of a gas turbine engine, the method comprising:
blending the damaged area of the component,
determining parameters for peening the damaged component, and
peening the damaged component without removing it from the engine.

2. The method of claim 1 wherein no part of the engine is masked.

3. The method of claim 1 wherein the parameters for peening are selected from a group consisting of: size and shape of the peening media; material of the peening media; size, frequency and amplitude of a vibrating surface of a peening apparatus; peening coverage; orientation of a vibrating surface of a peening apparatus with respect to a damaged area of the damaged component; and peening time.

4. The method of claim 1 wherein the peening is performed using a self-contained, automatic sonic peening apparatus.

5. The method of claim 1 wherein the peening is performed using a hand-held sonic peening apparatus.

6. The method of claim 1 wherein the damaged component is selected from a group consisting of: fan hubs, HPC front hubs, HPC discs and drums, turbine exhaust cases and front compressor drive turbine shafts.

7. A method for repairing a damaged component of a module of gas turbine engine, the method comprising:
removing the module from the engine,
blending the damaged area of the component,
determining parameters for peening the damaged component, and
peening the damaged component without removing it from the engine module.

8. The method of claim 7 wherein no part of the engine module is masked.

9. The method of claim 7 wherein the parameters for peening are selected from a group consisting of: size and shape of the peening media; material of the peening media; size, frequency and amplitude of a vibrating surface of a peening apparatus; peening coverage; orientation of a vibrating surface of a peening apparatus with respect to a damaged area of the damaged component; and peening time.

10. The method of claim 7 wherein the peening is performed using a self-contained, automatic sonic peening apparatus.

11. The method of claim 7 wherein the peening is performed using a hand-held sonic peening apparatus.

12. The method of claim 5 wherein the damaged component is selected from a group consisting of: HPC front hubs, HPC discs and drums, turbine exhaust cases, and front compressor drive turbine shafts.
